(19) United States
(12) Patent Application Publication
(10) Pub. No.: US 2025/0202788 A1
(43) Pub. Date: Jun. 19, 2025

(54) CONTROLLER PARAMETER ADAPTATION FOR NON-DIFFERENTIABLE COMMUNICATION CONDITIONS

(71) Applicant: Intel Corporation, Santa Clara, CA (US)

(72) Inventors: Luis Ruiz Fernandez, Santa Clara, CA (US); Rodrigo Aldana Lopez, Zapopan (MX); Javier Felip Leon, Hillsboro, OR (US); David Gomez Gutierrez, Tlaquepaque (MX); David Gonzalez Aguirre, Hillsboro, OR (US)

(21) Appl. No.: 19/065,013

(22) Filed: Feb. 27, 2025

(51) Int. Cl. H04L 43/08; H04L 43/16; H04L 67/125

(52) U.S. Cl. CPC H04L 43/08; H04L 43/16; H04L 67/125

(57) ABSTRACT

A system for adapting at least one parameter of a controller, the system including: processor circuitry; and a non-transitory computer-readable storage medium storing instructions that, when executed by the processor circuitry, cause the processor circuitry to: receive a robot model specification including differentiable robot dynamics, a controller specification including the at least one parameter, and a network condition specification including a non-differentiable discrete communication event; generate a differentiable simulation by: simulating the robot model specification; and transforming the non-differentiable discrete communication event into a continuous differentiable function based on a membership function; and tuning the at least one parameter using gradient-based optimization on the differentiable simulation to improve robot performance under the network condition specification; and output the tuned at least one parameter to configure the controller.

### BACKGROUND

Recent advancements in manufacturing have highlighted the growing adoption of networked control systems (NCS) and cyber-physical systems (CPS) as preferred solutions for managing complex and large-scale manufacturing processes. NCSs are systems where control algorithms are executed over communication networks, enabling distributed decision-making and real-time process monitoring. CPS, on the other hand, seamlessly integrates physical systems—such as robots and sensors—with advanced computing infrastructures, leveraging cloud and edge computing for high-level decision-making. This integration enhances scalability and supports the execution of complex tasks that would be challenging for traditional, isolated control systems to handle effectively. However, the reliance on communication networks introduces challenges, including latency variations (jitter) and throughput limitations, which can affect the reliability and efficiency of communication between controllers, decision-making units, and physical actuators or robots tasked with executing processes.

To address cost and installation complexity, wireless communication technologies are increasingly replacing wired communication in large-scale manufacturing systems. While wireless communication offers significant advantages, particularly in large or geographically dispersed systems, it also introduces challenges such as packet loss, delays, and aperiodic information exchange due to network congestion or interference. For instance, Wi-Fi networks commonly exhibit latency and jitter ranging from 7 ms to 25 ms. These issues can severely degrade the performance of robotic controllers, thereby reducing the overall efficiency of the manufacturing process. Such performance losses often propagate through the system, exacerbating scalability challenges by causing suboptimal task execution and system-wide inefficiencies. Decision-making units (DMUs), which may include controllers or planners operating on local computers or in edge/cloud environments, communicate their decisions and actions to robots via communication networks that are susceptible to various hazards.

### BRIEF DESCRIPTION OF THE FIGURES

FIG. 1 illustrates a block diagram of a networked control system in a manufacturing process in accordance with aspects of the disclosure.

FIG. 2A illustrates a block diagram of an auto-tuning platform for controllers in accordance with aspects of the disclosure.

FIG. 2B illustrates a block diagram of a simulation rollout module's operation for a single trajectory in accordance with aspects of the disclosure.

FIG. 2C illustrates a block diagram of an input tensor of initial conditions specified to simulate parallel trajectories in the processor unit in accordance with aspects of the disclosure.

FIG. 3 Illustrates a graph depicting a membership function as a function of condition in accordance with aspects of the disclosure.

FIG. 4A illustrates a diagram of an example manipulator.

FIGS. 4B and 4C illustrate graphs of a comparative analysis of the performances of the manipulator of FIG. 4A before and after implementing the auto-tuning platform of FIG. 2A in accordance with aspects of the disclosure.

FIG. 5 illustrates a block diagram of a system in accordance with aspects of the disclosure.

### DETAILED DESCRIPTION

To address these challenges, the disclosed technique automatically tunes robot controllers to operate effectively under imperfect communication conditions, including communication delays, sampling period jitter, and errors such as packet loss. It optimizes tunable control parameters within the control algorithms to function reliably in these conditions.

A challenge in these scenarios is the non-differentiable nature of the loss function, which makes traditional gradient descent methods less effective. To overcome this, the disclosed learning-based approach employs a simulation-driven optimization process that accounts for the robot model and the communication network's latency and throughput characteristics. This approach adapts control parameters using either neural network controllers—by tuning weights or kernels within their topologies—or traditional control schemes. For traditional controllers, it adjusts gains, feedforward and feedback modifiers, as well as smoothing and damping parameters, to mitigate the effects of communication irregularities. By doing so, this method ensures controllers remain adaptive and robust despite network imperfections.

The central idea is that while controller tuning may perform adequately under ideal communication conditions, alternative parameters can better accommodate the realities of manufacturing environments. Examples include:
Proportional-Integral-Derivative (PID) Controllers: Tuning of three gains (proportional, integral, and derivative) for effective performance.
Linear Quadratic Regulator (LQR) Controllers: Tuning a gain matrix based on a specific quadratic cost function.
Neural Network (NN) Controllers: Tuning neuron weights to achieve desired performance metrics based on a defined cost function/performance index.

The disclosed platform integrates these principles to find improved control parameters by solving a simulation-based optimization problem. This process is guided by the robot model and the communication network's latency and throughput characteristics. As a result, the approach enhances robustness against communication imperfections commonly encountered in real-world manufacturing environments.

### Networked Control System

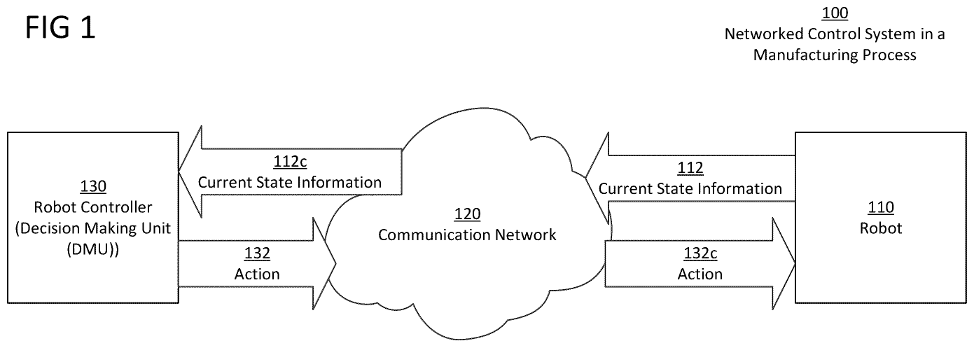

FIG. 1 illustrates a networked control system 100 in a manufacturing process in accordance with aspects of the disclosure.

A robot 110 transmits its current state information 112 over a communication network 120 to a controller 130 (also referred to as a Decision-Making Unit, or DMU). The controller 130 uses this state information to compute actions 132, which are then sent back to the robot 110. However, the communication network 120 introduces potential issues, such as delays, jitter, and packet loss-particularly when using streaming protocols like the User Datagram Protocol (UDP). To mitigate these issues, the robot 110 employs a Zero-Order Hold strategy, retaining the last received control action 132 until a new one arrives.

These communication challenges can significantly impact control performance. To address them, the disclosed solution adapts control parameters to enhance system robustness against imperfect communication. This ensures that the closed-loop system maintains improved performance even in large-scale deployments with congested networks.

### Auto-Tuning Platform

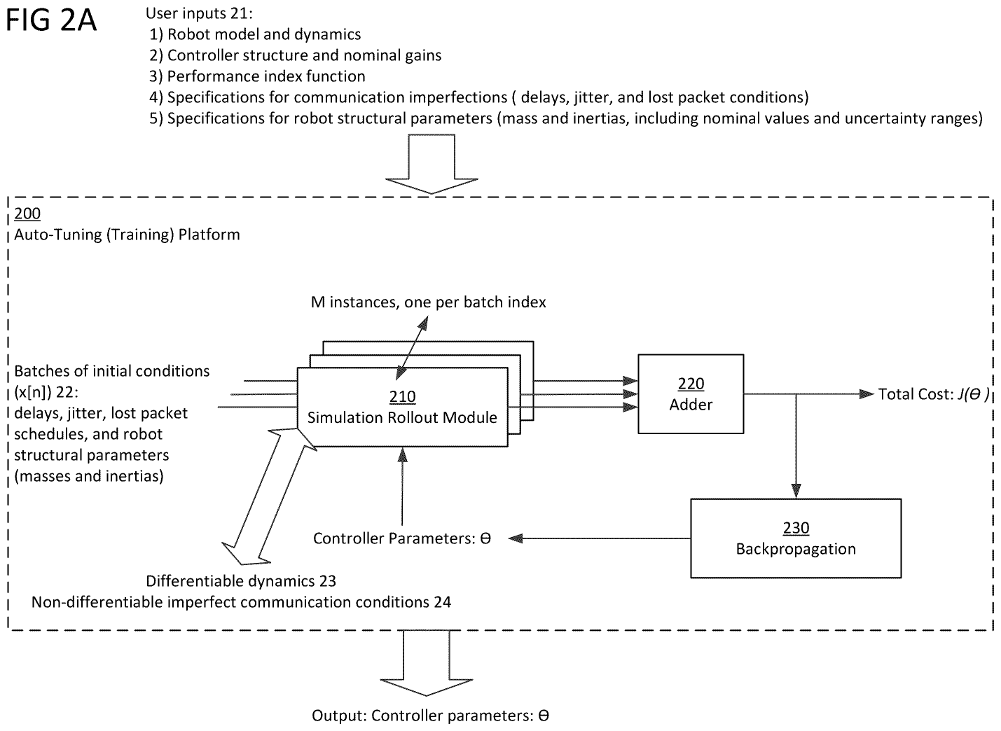

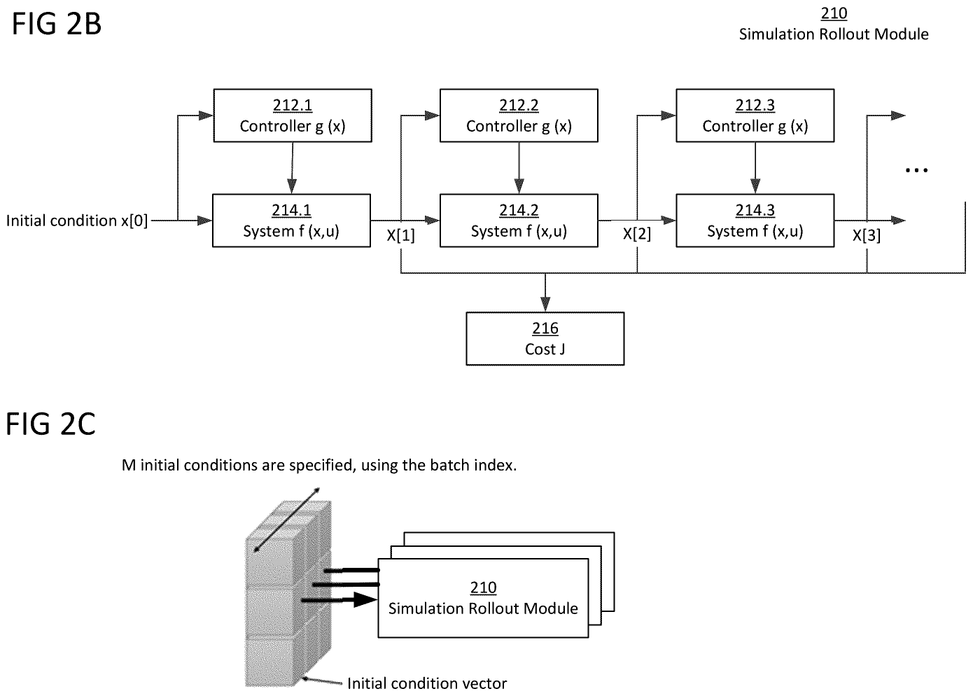

FIG. 2A illustrates a block diagram of an auto-tuning platform 200 for controllers 130 in accordance with aspects of the disclosure.

This auto-tuning (or training) platform 200 is learning-based and designed to address communication imperfections, such as delays, jitter, and lost packets, by integrating these factors into the training process. The robot 110's behavior is simulated using a differentiable simulation solver, which enables backpropagation through parallelized simulations that leverage processor resources (e.g., GPUs). Differentiability is ensured by blending control decisions under varying communication conditions, facilitating smooth gradient optimization. This approach is flexible and robust, capable of adapting to various robot models and accommodating imperfect parameterization, making it well-suited for large-scale manufacturing systems. The auto-tuning platform 200 enables the application of gradient descent-based methods to scenarios with communication imperfections, offering faster convergence and better adaptability. While initially developed for manufacturing systems, this solution exi ends to optimizing controllers for autonomous robots, which navigate complex, dynamic environments influenced by exi ernal conditions.

The auto-tuning platform 200 receives user inputs 21, including the robot model and dynamics specifications, controller structure with nominal gains, a performance index function, specifications for communication imperfections (e.g., delays, jitter, and lost packet conditions), and robot structural parameters, such as mass and inertias including both nominal values and uncertainty ranges.

The auto-tuning platform 200 runs on processor unit hardware (e.g., GPUs, FPGAS, ASICs, or the like) to enable parallel processing, with M parallel instances, each corresponding to a different batch index. It processes batches of initial conditions 22 for communication imperfection schedules (e.g., delays, jitter, lost packets, etc.) and robot structural parameters (e.g., masses and inertias)

A component is the simulation rollout module 210, which incorporates both differentiable dynamics and non-differentiable communication imperfections. This simulation rollout module 210 enables the auto-tuning platform 200 to simulate robot behavior under various communication network conditions while maintaining differentiability across the simulation pipeline. The simulation results are fed into an adder 220 that computes the total cost J (θ), where θ represents the controller parameters.

The auto-tuning platform 200 employs backpropagation 230, particularly in the example of neural network controllers, to optimize these controller parameters, leveraging the differentiable nature of the system. This optimization process adjusts the parameters to improve controller performance under the specified communication imperfections. The final output of the auto-tuning platform 200 is a more robust set of controller parameters θ, tuned to provide reliable performance under given communication network conditions.

The auto-tuning platform 200's architecture combines differentiable robot dynamics 23 with non-differentiable communication events 24 into a unified, differentiable optimization framework. This integration enables efficient parameter tuning for robust controller performance. Additionally, the platform supports simultaneous optimization across multiple scenarios and conditions, leveraging processor unit parallelization to accelerate the tuning process.

More specifically, the auto-tuning platform 200 is configured to receive the following user-specified inputs 21, including the relevant equations:

First, the user specifies the robot model and its dynamics for simulation training. The robot 110's dynamics are represented by a state equation:

$$x [ k + 1 ] = f ( x [ k ] , u [ k ] ) , \qquad ( Equation 1 )$$

where x [k] is the state of the robot 110 and u [k] is the state of the controller 130. Thus, the user specifies the function ƒ.

Second, the user specifies the controller structure, which can be either a custom design, such as a neural network, or a vendor-provided controller if it supports parameter modification. The controller structure is represented as:

$$u [ k ] = g ( x [ k ] ; θ ) , \qquad ( Equation 2 )$$

where θ represents the control gains or parameters of the controller 130, which are to be determined. The function g defines the control strategy and is specified. For instance, g (·; θ) may represent a basic proportional integral derivative (PID) controller with gains encapsulated in θ, a more advanced Linear Quadratic Regulator (LQR) controller, or even a fully connected neural network, such as a Multi-Layer Perceptron (MLP), whose weights contained in θ.

Third, the user defines a cost function (performance index) to evaluate the outcome of a given experiment. The cost is defined as a function of a trajectory in the form:

$$J = h ( x [ 1 ] , ... , x [ K ] ) , \qquad ( Equation 3 )$$

where K denotes the window size. Examples of cost indices include the LQR cost, which accounts for factors such as tracking errors, large transients, and overshoots, enabling a comprehensive assessment of the system's performance.

Fourth, the user specifies the expected communication characteristics, including delays, jitters, and lost packet rates, along with their probability distributions and their maximum/minimum values.

Fifth, the user specifies the robot 110's structural parameters, such as mass and inertia, which are contained within the function f of Equation 1 above. While these parameters are necessary for simulation, the user may also specify their variation ranges.

The auto-tuning platform 200 utilizes this input information 21, 22 to generate appropriate control parameters θ, enhancing the robot 110's robustness under user-specified conditions of imperfect communication. To improve computational efficiency, auto-tuning platform 200 employs a nonlinear optimization process that simulates the user-defined system multiple times. It leverages machine learning platforms, employing processor-based (e.g., GPU-based) parallelization and automatic gradient tracking for efficient computation. These capabilities enable faster computations and optimization, ensuring a practical and scalable solution.

Since the user can define any dynamic system for the robot 110 and specify any cost function J—provided they are differentiable—two additional factors can optionally be incorporated into the approach.

The first additional factor relates to safety constraints, which may be necessary due to exi ended communication latencies. For example, actuator limits can be imposed based on the prevailing communication conditions. These constraints are incorporated into the dynamic system ƒ(x [k], u [k]) by saturating the input u [k] appropriately within function ƒ.

The other additional factor involves preventing undesirable overshoots in the presence of latencies. To address this, the user can modify the performance index J by adding an additional penalty term. A common method to discouraging overshooting is incorporating quadratic terms of the form x [k]^{T}Q [k] x [k]. By enforcing/regularizing positive-definite matrices Q [k], these terms can be given more weight during transient periods, effectively penalizing overshoots and improving system stability.

### First Simulator Component: Parallel Differentiable Dynamic System Simulator

The simulation process relies on two primary simulator components: (1) a parallel differentiable dynamic system simulator; and (2) a differentiable imperfect communication simulator.

FIG. 2B illustrates a block diagram of the simulation rollout module 210's operation for a single trajectory in accordance with aspects of the disclosure.

The parallel differentiable dynamic system simulator utilizes the auto-tuning platform 200's capabilities to evaluate robot control parameters θ by simulating multiple system trajectories in parallel under different conditions. These parameters can range from basic PID controller gains to the weights of a fully connected Multi-Layer Perceptron (MLP) neural network. In each simulation, three functions—ƒ, g, J-represent the system dynamics 214, the controller 212, and the cost function 216, respectively, in a manner analogous to a neural network's feedforward execution. The simulation rollout module 210 proceeds in discrete time, beginning from an initial condition x [0] and evolving step-by-step. At each step, the controller g (x) 212 processes the current state and generates an output, which is then passed to the system ƒ(x,u) 214, and discrete events such as delays or packet loss may occur. This process continues from time 0 to time 1, from time 1 to time 2, and so on, generating states x [1], x [2], x [3], and beyond, until a complete trajectory of a window of length K is generated. The final trajectory is evaluated using the cost function J to determine the system's performance.

FIG. 2C demonstrates how the simulation framework leverages parallel processing to evaluate multiple trajectories simultaneously. A batch of M initial conditions is defined, with each condition represented as a vector (or column in a matrix). Each vector serves as the starting point for a distinct instance of the simulation rollout module 210, which simulates a single trajectory based on that initial condition. By organizing these initial conditions into a matrix and processing them concurrently-using processor units such as GPUs—the system achieves significantly higher computational efficiency than sequential methods. This parallelized approach also facilitates the introduction of variations in robot parameters (e.g., masses and inertias) to encompass a wider range of operational scenarios.

With these capabilities, the accumulated cost across all trajectories can be computed, as illustrated in FIG. 2A. Due to the structural similarity between this simulation and a neural network feedforward execution, shown in FIG. 2B, backpropagation can be applied. This allows gradients to be computed for the cost function back to the controller function g, optimizing the parameters θ of the controller 130. As a result, the system can refine its parameters to enhance overall performance.

### Second Simulator Component: Differentiable Imperfect Communication Simulator

The second primary simulator component is the differentiable imperfect communication simulator. This module models the effects of imperfect communication-such as delays, jitter, and packet loss-within the simulation rollout module 210 described earlier. For each trajectory, random schedules for jitter, delay, and lost packets are generated.

The controller u [k]=g (\tilde{x}; θ) is updated accordingly, where \tilde{x} represents the most recent state value known to the controller 130, which may be affected by delays. At each time step k, the simulation determines whether the values of u [k] and \tilde{x} should be updated with new data or retained from the previous time step.

This introduces discrete conditional evaluations, which pose challenges for computing gradients from the cost function J to the parameters θ. To overcome this, this disclosure presents a differentiable method for handling these conditional checks.

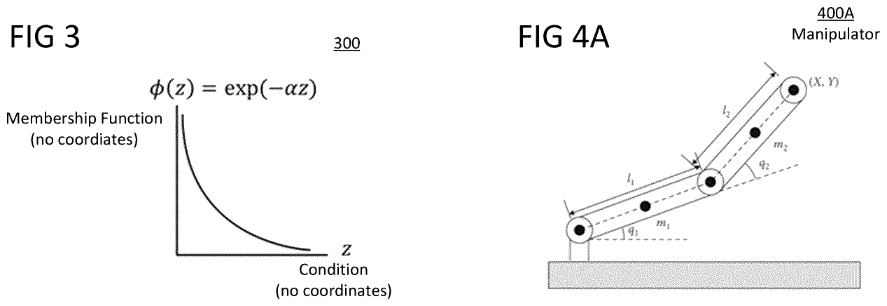

FIG. 3 illustrates a graph 300 depicting a membership function ϕ as a function of condition z in accordance with aspects of the disclosure.

One approach to implementing this differentiable logic is to define k₁, . . . , k_{N} as the time instances at which updates to u or \tilde{x} should occur. The controller 130 is represented as:

$${c}_{k} = ϕ ( min \{ {\vert k - {k}_{ℓ} \vert}_{ℓ = 1 , ... , N} \} ) . \qquad ( Equation 4 )$$

Here, ϕ is a decreasing membership function, such as a decaying exponential:

$$ϕ ( z ) = exp ( - α z ) , \qquad ( Equation 5 )$$

where α is the parameter that determines the steepness of the membership function. Using this formulation, the controller 130 at the next step is computed as:

$$u [ k + 1 ] = {c}_{k} g ( \tilde{x} ; θ ) + ( 1 - {c}_{k} ) u [ k ] \qquad ( Equation 6 )$$

If the time k is far from any of the update times k₁, . . . , k_{N}, then, cₖ≈0, meaning u [k+1] ≈u [k], preserving the previous control action. Conversely, if k is close to an update time, then cₖ≈1, leading to u [k+1] ≈g (\tilde{x}; θ), which updates the control action.

This approach seamlessly integrates the update logic into the simulation rollout module 210. By adopting a differentiable formulation, the cost function J and its gradient with respect to θ can be efficiently computed, facilitating effective optimization.

### System Performance

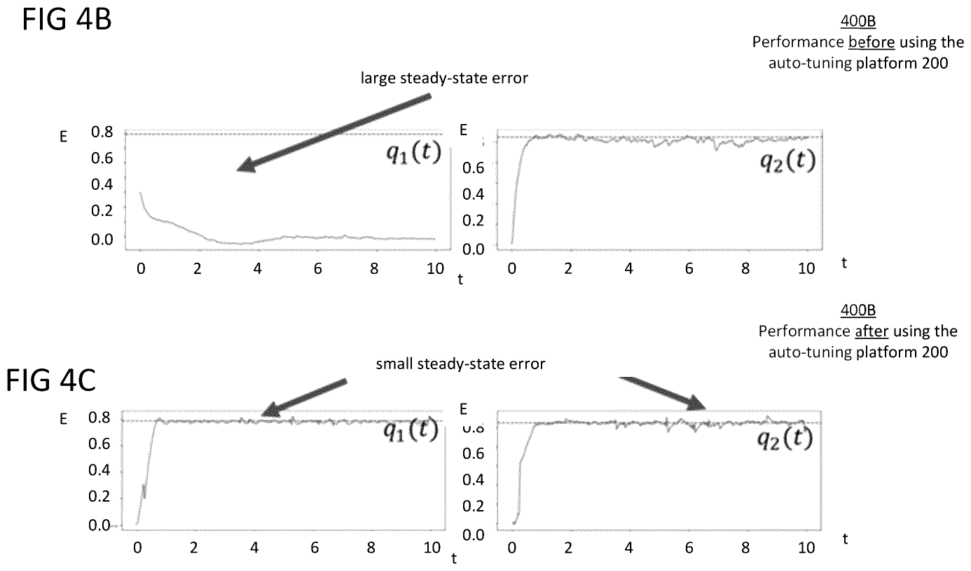

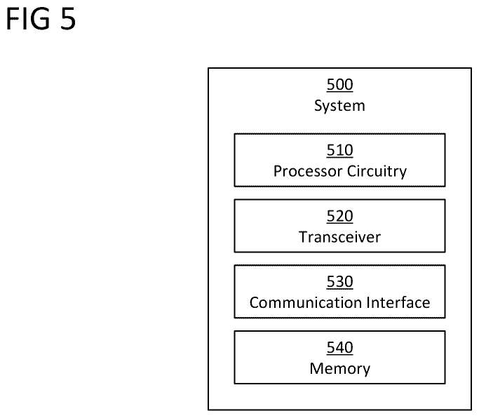

FIG. 4A illustrates an example manipulator 400A, which has two degrees of freedom (q₁, q₂). The manipulator 400A has two connected segments with lengths I₁ and I₂, masses m₁ and m₂, and joint angles q₁ and q₂.

FIGS. 4B and 4C illustrate graphs 400B and 400C, respectively, depicting a comparative analysis of the manipulator 400A's performance before and after implementing the auto-tuning platform 200 of FIG. 2A in accordance with aspects of the disclosure.

FIG. 4B illustrates graph 400B, which represents controller 130's performance using a nominal controller with parameters θₙₒₘᵢₙₐₗ designed for ideal communication conditions. The nominal controller utilizes a sliding mode controller equipped with a differentiator for each angle. The parameters θ define the gains for both the sliding mode and the differentiator, which are optimized to drive the coordinates q₁, q₂ to the origin as the setpoint. Under ideal communication conditions, this controller effectively reduces tracking errors. However, under imperfect communication conditions, where jitter ranges from 1 ms to 50 ms (as commonly observed in Wi-Fi networks, which typically experience jitter between 7 ms and 25 ms), the system undergoes significant performance degradation. This degradation is particularly evident in the large steady-state error in the q₁ (t) coordinate.

FIG. 4C presents a graph 400C, which depicts the controller 130's performance after applying the proposed auto-tuning method. Using the same imperfect communication conditions, the controller 130 exhibits significantly improved performance, with both q₁ (t) and q₂ (t) showing reduced steady-state error.

To quantify the improvement, a metric based on the squared norm of the error vector between states and their reference values in the steady state is used:

$$E = \frac{1}{N} {\sum }_{k = 1}^{N} ‖ {e}_{i} ‖ \qquad ( Equation 7 )$$

where ext represents the error at the i-th time step. Without the disclosed method, the error value is 1.41439. With the disclosed approach and training the controller 130 under the same imperfect communication conditions, updated parameters θ are obtained. Evaluating the controller 130 with these optimized parameters results in a significantly reduced error of 0.051. The results, illustrated in FIG. 4C, demonstrate that the disclosed method achieves approximately a 30× improvement in accuracy compared to the nominal controller.

### Adaptation to New or Multiple Scenarios

The disclosed approach is designed to be robust to persistent communication conditions rather than adapting to spontaneous changes in the communication network. For instance, the system handles consistent network traffic that causes delays, jitter, and packet loss. During training, the system is optimized for a specific distribution of these network conditions. However, network changes-such as the addition of new machines in a factory or modifications to the network infrastructure—may require a different set of control parameters. Similarly, network traffic in manufacturing environments often fluctuates depending on the time of day or week.

To reduce conservatism, multiple sets of parameters can be pre-trained for various scenarios. While a technician can identify likely scenarios requiring distinct parameters, detecting when a parameter change is necessary involves satisfying two conditions.

The first condition is the direct monitoring of network conditions. By integrating a network sniffer and analyzing controller logs, network metrics such as delays, jitter, and packet loss can be directly measured. A statistical characterization of these metrics over a time window can then be compared to pre-trained scenarios. If the observed conditions deviate significantly from the trained scenarios, retraining may be indicated.

The second condition is monitoring error and performance indices. Even if network conditions change, the controller may still maintain acceptable performance. During training, an expected performance threshold is defined based on simulations. If the current performance deteriorates significantly due to a change in network conditions, this indicates the need for retraining.

### Computing System

FIG. 5 illustrates a system 500 in accordance with aspects of the disclosure.

The component 500 may be identified with a central controller and be implemented as any suitable network infrastructure component, which may be implemented as a cloud/edge network server, controller, computing device, etc. The component 500 may include processor circuitry 510, a transceiver 520, a communication interface 530, and a memory 540. The components shown in FIG. 5 are provided for ease of explanation, and the component 500 may implement additional, fewer, or alternative components than those shown in FIG. 5.

The processor circuitry 510 may be operable as any suitable number and/or type of computer processor that may function to control the component 500. The processor circuitry 510 may be identified with one or more processors (or suitable portions thereof) implemented by the component 500. The processor circuitry 510 may be identified with one or more processors such as a host processor, a digital signal processor, one or more microprocessors, graphics processors, baseband processors, microcontrollers, an application-specific integrated circuit (ASIC), a portion (or the entirety of) a field-programmable gate array (FPGA), etc.

In any case, the processor circuitry 510 may be operable to execute instructions to perform arithmetic, logic, and/or input/output (I/O) operations and/or to control the operation of one or more components of the component 500 to perform various functions as described herein. The processor circuitry 510 may include one or more microprocessor cores, memory registers, buffers, clocks, etc. It may generate electronic control signals associated with the components of the component 500 to control and/or modify the operation of those components. The processor circuitry 510 may communicate with and/or control functions associated with the transceiver 520, the communication interface 530, and/or the memory 540. The processor circuitry 510 may additionally perform various operations to control the communications, communications scheduling, and/or operation of other network infrastructure components communicatively coupled to the component 500.

The transceiver 520 may be implemented as any suitable number and/or type of components operable to transmit and/or receive data packets and/or wireless signals in accordance with any suitable number and/or type of communication protocols. The transceiver 520 may include any suitable type of components to facilitate this functionality, including components associated with known transceiver, transmitter, and/or receiver operations, configurations, and implementations. Although shown as a transceiver in FIG. 5, the transceiver 520 may include any suitable number of transmitters, receivers, or combinations thereof, which may be integrated into a single transceiver or as multiple transceivers or transceiver modules. The transceiver 520 may include components typically identified with a radio frequency (RF) front end and include, for example, antennas, ports, power amplifiers (PAS), RF filters, mixers, local oscillators (LOs), low noise amplifiers (LNAs), up-converters, down-converters, channel tuners, etc.

The communication interface 530 may be implemented as any suitable number and/or type of components operable to facilitate the transceiver 520 to receive and/or transmit data and/or signals in accordance with one or more communication protocols, as discussed herein. The communication interface 530 may be implemented as any suitable number and/or type of components operable to interface with the transceiver 520, such as analog-to-digital converters (ADCs), digital-to-analog converters, intermediate frequency (IF) amplifiers and/or filters, modulators, demodulators, baseband processors, and the like. The communication interface 530 may thus operate in conjunction with the transceiver 520 and form part of an overall communication circuitry implemented by the component 500, which may be implemented via the component 500 to transmit commands and/or control signals to perform any of the functions described herein.

The memory 540 is operable to store data and/or instructions such that when the instructions are executed by the processor circuitry 510, they cause the component 500 to perform various functions as described herein. The memory 540 may be implemented as any known volatile and/or non-volatile memory, including, for example, read-only memory (ROM), random access memory (RAM), flash memory, a magnetic storage medium, an optical disk, erasable programmable read-only memory (EPROM), programmable read-only memory (PROM), etc. The memory 540 may be non-removable, removable, or a combination of the two. The memory 540 may be implemented as a non-transitory computer-readable medium storing one or more executable instructions such as logic, algorithms, code, etc.

As further discussed below, the instructions, logic, code, etc., stored in the memory 540 are represented by the various modules/engines as shown in FIG. 5. Alternatively, when implemented via hardware, the modules/engines shown in FIG. 5 associated with the memory 540 may include instructions and/or code to facilitate control and/or monitoring of the operation of such hardware components. In other words, the modules/engines shown in FIG. 5 are provided to facilitate an explanation of the functional association between hardware and software components. Thus, the processor circuitry 510 may execute the instructions stored in these respective modules/engines in conjunction with one or more hardware components to perform the various functions discussed herein.

Various aspects described herein may utilize one or more machine learning models for the controller 130. The term “model,” as used herein, may be understood to mean any type of algorithm that provides output data from input data (e.g., any type of algorithm that generates or calculates output data from input data). A machine learning model can be executed by a computing system to progressively improve the performance of a particular task. In some aspects, the parameters of a machine learning model may be adjusted during a training phase based on training data. A trained machine learning model may be used during an inference phase to make predictions or decisions based on input data. In some aspects, the trained machine learning model may be used to generate additional training data. An additional machine learning model may be tuned during a second training phase based on the generated additional training data. A trained additional machine learning model may be used during an inference phase to make predictions or decisions based on input data.

The machine learning models described herein may take any suitable form or utilize any suitable technique (e.g., for training purposes). For example, each of the machine learning models may utilize supervised learning, semi-supervised learning, unsupervised learning, or reinforcement learning techniques.

In supervised learning, the model may be built using a training set of data that includes both the inputs and the corresponding desired outputs (illustratively, each input may be associated with a desired or expected output for that input). Each training instance may include one or more inputs and a desired output. Training may involve iterating through training instances and using an objective function to teach the model to predict the output for new inputs (illustratively, for inputs not included in the training set). In semi-supervised learning, a portion of the inputs in the training set may lack corresponding desired outputs (e.g., one or more inputs may not be associated with any desired or expected output).

In unsupervised learning, the model may be built from a training set of data that includes only inputs and no desired outputs. The unsupervised model may be used to find structure in the data (e.g., grouping or clustering of data points), for example, by discovering patterns in the data. Techniques that may be implemented in an unsupervised learning model may, for example, self-organizing maps, nearest-neighbor mapping, k-means clustering, and singular value decomposition.

Reinforcement learning models may include positive or negative feedback to improve accuracy. A reinforcement learning model may attempt to maximize one or more goals/rewards. Techniques that may be implemented in a reinforcement learning model may include, for example, Q-learning, temporal difference (TD), and deep adversarial networks.

Various aspects described herein may utilize one or more classification models. In a classification model, outputs may be restricted to a limited set of values (e.g., one or more classes). The classification model may output a class for an input set of one or more input values. An input set may include sensor data, such as image data, radar data, LIDAR (light detection and ranging) data, and the like. A classification model as described herein may, for example, classify certain driving conditions and/or environmental conditions, such as weather conditions, road conditions, and the like. References herein to classification models may contemplate a model that implements, for example, one or more of the following techniques: linear classifiers (e.g., logistic regression or naive Bayes classifier), support vector machines, decision trees, boosted trees, random forest, neural networks, or nearest neighbor.

Various aspects described herein may utilize one or more regression models. A regression model may output a numerical value from a continuous range based on an input set of one or more values (e.g., starting from or using an input set of one or more values). References herein to regression models may contemplate a model that implements, for example, one or more of the following techniques (or other suitable techniques): linear regression, decision trees, random forests, or neural networks.

A machine learning model described herein may be or include a neural network. The neural network may be any type of neural network, such as a convolutional neural network, an autoencoder network, a variational autoencoder network, a sparse autoencoder network, a recurrent neural network, a deconvolutional network, a generative adversarial network, a forward-thinking neural network, a sum-product neural network, and the like. The neural network can have any number of layers. The training of the neural network (e.g., the adaption of the layers of the neural network) may use or be based on any kind of training principle, such as backpropagation (e.g., using the backpropagation algorithm).

Gradient-based training is highly efficient, typically completed within minutes to a few hours. This makes retraining feasible when changes in factory infrastructure occur. Once retrained, maintenance or quality technicians can validate the updated parameters to ensure they meet operational standards before deployment.

The demand for optimizing manufacturing processes continues to grow, driven by competitive pressures and the need for efficiency. A strategy to achieve this optimization is the large-scale adoption of collaborative robots (cobots) and autonomous mobile robots (AMRs). These robots are already widely utilized in industries such as warehousing for tasks like transportation, picking, and placing items.

However, silicon manufacturing presents significantly more complex challenges, including maintenance and assembly tasks that require seamless collaboration between multiple robots and humans. This level of collaboration necessitates advanced perception and decision-making capabilities, often requiring computational workloads to be offloaded to edge devices.

To support such large-scale collaborative robotic systems, networked control installations are important. However, these installations introduce communication issues such as jitter and delays, which can severely degrade the performance of existing control algorithms. Furthermore, the flexibility and mobility required in these systems favor the use of wireless communications, which exacerbate these challenges.

The solution disclosed herein addresses these critical issues by enhancing the precision, efficiency, and safety of controllers in networked robotic systems. By tackling these challenges at the controller level, this approach provides a significant competitive advantage in robotic task coordination.

The disclosed solution is advantageous over previous solutions. For example, nominal controllers provided by robot or machine manufacturers often fail to perform effectively under networked control systems. Adapting these controllers to account for imperfect communication typically requires manual parameter adjustments by expert technicians, which is time-consuming, costly, and prone to human error.

While reinforcement learning (RL) techniques are used to adapt controller parameters, they face significant limitations. Delays, jitter, and packet loss introduce non-differentiable features, rendering backpropagation techniques ineffective. As a result, RL-based solutions cannot directly address these hazards. Additionally, RL policies are often environment—and robot-specific, limiting their ability to generalize beyond the conditions and systems used during training.

With unsupervised learning, techniques like Principal Component Analysis (PCA) have been employed to determine control parameters in the presence of delays and packet loss. However, these methods have demonstrated effectiveness only for simple robots and are not scalable to more complex or diverse robotic systems. While unsupervised learning methods can adapt to delays and communication issues, they are highly tailored to specific configurations. Extending these models to arbitrary systems requires extensive retraining or additional data, significantly reducing flexibility.

Linear Matrix Inequality (LMI)-based control provides formal guarantees for handling delays, jitter, and packet loss. However, these guarantees are limited to conservative scenarios and are not scalable to complex or large-scale systems due to the computational complexity. Though adaptable to specific scenarios, LMI-based methods are problem-specific, computationally intensive, and not easily applicable to arbitrary robot platforms, limiting their practical utility in diverse networked control systems.

In contrast, the disclosed approach operates at the controller level rather than intervening in the network layer. By optimizing controller gains, our method enhances robustness against jitter and packet loss without requiring modifications to the communication infrastructure. Unlike network-focused solutions, our method emphasizes adaptability across diverse robotic systems and control architectures, ensuring reliable performance even under imperfect communication conditions. Additionally, compared to co-design strategies that tightly couple communication and control, our approach offers greater flexibility, enabling seamless application across a wide range of robots and environments without dependency on specific infrastructure.

In contrast, the disclosed solution adapts controller parameters to account for latency, jitter, and packet loss in networked control manufacturing systems. Unlike previous solutions, it is flexible enough to support a wide range of robots and actuators.

The disclosed solution optimizes both continuous and discrete parameters, focusing on enhancing the robustness of pre-established controller gains rather than directly addressing individual communication issues. This approach enables broad applicability to linear and nonlinear systems and various control architectures, making it a scalable and adaptable solution for modern manufacturing environments.

The techniques of this disclosure may also be described in the following examples.

Example 1. A system for adapting at least one parameter of a controller, the system comprising: processor circuitry; and a non-transitory computer-readable storage medium storing instructions that, when executed by the processor circuitry, cause the processor circuitry to: receive a robot model specification including differentiable robot dynamics, a controller specification including the at least one parameter, and a network condition specification including a non-differentiable discrete communication event; generate a differentiable simulation by: simulating the robot model specification; and transforming the non-differentiable discrete communication event into a continuous differentiable function based on a membership function; and tuning the at least one parameter using gradient-based optimization on the differentiable simulation to improve robot performance under the network condition specification; and output the tuned at least one parameter to configure the controller.

Example 2. The system of example 1, wherein the membership function is a decreasing exponential membership function that transforms control decisions based on proximity to a communication event time.

Example 3. The system of any of examples 1-2, wherein the generating the differentiable simulation comprises executing parallel simulations of robot trajectories, wherein each simulation uses different combinations of initial network conditions.

Example 4. The system of example 3, wherein the instructions further cause the processor circuitry to: generate a plurality of simulation instances; compute an individual cost for each simulation instance; combine the individual costs to generate a total cost; and perform backpropagation from the total cost through the simulation instances to tune the at least one parameter.

Example 5. The system of example 3, wherein the instructions further cause the processor circuitry to: define a cost function to evaluate the parallel simulations of robot trajectories based on a tracking error or an overshoot; and tune the at least one parameter to reduce the cost function.

Example 6. The system of example 5, wherein the cost function includes quadratic terms to penalize overshooting during transient responses.

Example 7. The system of any of examples 1-6, wherein the non-differentiable discrete communication event comprises a communication delay, a communication jitter, and a packet loss rate.

Example 8. The system of any of examples 1-7, wherein the non-differentiable discrete communication event comprises a communication delay range, a communication jitter range, and a packet loss rate range.

Example 9. The system of any of examples 1-8, wherein the controller specification comprises: a proportional-integral-derivative (PID) controller with gain parameters; a linear quadratic regulator (LQR) controller with matrix gain parameters; or a neural network (NN) controller with weight parameters.

Example 10. The system of any of examples 1-9, wherein the instructions further cause the processor circuitry to: monitor communication conditions during operation of the robot; detect a change in the communication conditions that exceed a threshold; and trigger retraining using another differentiable simulation based on the detected change.

Example 11. The system of any of examples 1-10, wherein the robot model specification comprises mass and inertia parameters.

Example 12. The system of any of examples 1-11, wherein the generating the differentiable simulation includes incorporating safety constraints by saturating control inputs according to actuator limits.

Example 13. The system of any of examples 1-12, wherein the generating the differentiable simulation comprises: receiving an initial condition state; performing a simulation rollout by: applying the controller to generate a control action based on a current state; simulating the robot model using the control action to generate a next state; iteratively repeating the applying and simulating steps for a specified number of timesteps to generate a trajectory; and computing a cost value for the trajectory in its entirety.

Example 14. The system of any of examples 1-13, wherein generating the differentiable simulation comprises: receiving a batch of initial conditions as an input tensor; and for each initial condition in the batch, performing a parallel simulation to generate a trajectory, wherein the parallel simulations are executed simultaneously, wherein the batch of initial conditions includes different combinations of: robot starting positions; robot mass and inertia parameters within specified variation ranges; and network condition parameters including delays, jitter, and packet loss schedules.

Example 15. The system of any of examples 1-14, wherein the network condition specification is a wireless network condition specification.

While the foregoing has been described in conjunction with exemplary aspects, it is understood that the term exemplary is merely meant as an example, rather than the best or optimal. Accordingly, the disclosure is intended to cover alternatives, modifications, and equivalents, which may be included within the scope of the disclosure.

Although specific aspects have been illustrated and described herein, it will be appreciated by those of ordinary skill in the art that a variety of alternate and/or equivalent implementations may be substituted for the specific aspects shown and described without departing from the scope of the present application. This application is intended to cover any adaptations or variations of the specific aspects discussed herein.

1. A system for adapting at least one parameter of a controller, the system comprising:
processor circuitry; and
a non-transitory computer-readable storage medium storing instructions that, when executed by the processor circuitry, cause the processor circuitry to:
receive a robot model specification including differentiable robot dynamics, a controller specification including the at least one parameter, and a network condition specification including a non-differentiable discrete communication event;
generate a differentiable simulation by:
simulating the robot model specification; and
transforming the non-differentiable discrete communication event into a continuous differentiable function based on a membership function; and
tuning the at least one parameter using gradient-based optimization on the differentiable simulation to improve robot performance under the network condition specification; and
output the tuned at least one parameter to configure the controller.

2. The system of claim 1, wherein the membership function is a decreasing exponential membership function that transforms control decisions based on proximity to a communication event time.

3. The system of claim 1, wherein the generating the differentiable simulation comprises executing parallel simulations of robot trajectories, wherein each simulation uses different combinations of initial network conditions.

4. The system of claim 3, wherein the instructions further cause the processor circuitry to:
generate a plurality of simulation instances;
compute an individual cost for each simulation instance;
combine the individual costs to generate a total cost; and
perform backpropagation from the total cost through the simulation instances to tune the at least one parameter.

5. The system of claim 3, wherein the instructions further cause the processor circuitry to:
define a cost function to evaluate the parallel simulations of robot trajectories based on a tracking error or an overshoot; and
tune the at least one parameter to reduce the cost function.

6. The system of claim 5, wherein the cost function includes quadratic terms to penalize overshooting during transient responses.

7. The system of claim 1, wherein the non-differentiable discrete communication event comprises a communication delay, a communication jitter, and a packet loss rate.

8. The system of claim 1, wherein the non-differentiable discrete communication event comprises a communication delay range, a communication jitter range, and a packet loss rate range.

9. The system of claim 1, wherein the controller specification comprises:
a proportional-integral-derivative (PID) controller with gain parameters;
a linear quadratic regulator (LQR) controller with matrix gain parameters; or
a neural network (NN) controller with weight parameters.

10. The system of claim 1, wherein the instructions further cause the processor circuitry to:
monitor communication conditions during operation of the robot;
detect a change in the communication conditions that exceed a threshold; and
trigger retraining using another differentiable simulation based on the detected change.

11. The system of claim 1, wherein the robot model specification comprises mass and inertia parameters.

12. The system of claim 1, wherein the generating the differentiable simulation includes incorporating safety constraints by saturating control inputs according to actuator limits.

13. The system of claim 1, wherein the generating the differentiable simulation comprises:
receiving an initial condition state;
performing a simulation rollout by:
applying the controller to generate a control action based on a current state;
simulating the robot model using the control action to generate a next state;
iteratively repeating the applying and simulating steps for a specified number of timesteps to generate a trajectory; and
computing a cost value for the trajectory in its entirety.

14. The system of claim 1, wherein generating the differentiable simulation comprises:
receiving a batch of initial conditions as an input tensor; and
for each initial condition in the batch, performing a parallel simulation to generate a trajectory, wherein the parallel simulations are executed simultaneously,
wherein the batch of initial conditions includes different combinations of:
robot starting positions;
robot mass and inertia parameters within specified variation ranges; and
network condition parameters including delays, jitter, and packet loss schedules.

15. The system of claim 1, wherein the network condition specification is a wireless network condition specification.
